(19) United States
(12) Patent Application Publication
(10) Pub. No.: US 2002/0085013 A1
(43) Pub. Date: Jul. 4, 2002

(54) Scan synchronized dual frame buffer graphics subsystem

(76) Inventor: Louis A. Lippincott, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/753,259

(22) Filed: Dec. 29, 2000

(51) Int. Cl. G06F 15/167; G06F 12/06; G09G 5/39

(52) U.S. Cl. 345/572; 345/542; 345/531

(57) ABSTRACT

A scan synchronized frame buffer architecture includes a primary frame buffer implemented as part of a unified memory architecture (UMA) memory, and a secondary frame buffer implemented on a chipset/graphics component that is in communication with the UMA memory. When a pixel is changed in the primary frame buffer, that pixel is copied to the secondary frame buffer when the pixel is needed by the display. In particular, the pixel is transmitted simultaneously to a digital to analog converter and the secondary frame buffer, synchronized to the display refresh. This action mimics the effect the primary frame buffer would have on the display if the primary frame buffer were the actual frame buffer maintaining the display. Most of the bandwidth for maintaining display refresh is handled by the secondary frame buffer, returning substantially all of the bandwidth back to the UMA memory.

### BACKGROUND OF THE INVENTION

1. Field of the Invention

The invention relates generally to the field of computer graphics and, more particularly to, a method and apparatus for efficiently displaying pixels stored in a dual frame buffer graphics subsystem.

2. Background Information

Generally, in computer graphic systems, a frame buffer is implemented in conjunction with a computer display monitor. For the displayed image to be visible, the frame buffer's entire contents need to be transferred to the display continuously. In particular, the frame buffer contains pixels in a digitized form for display on the corresponding monitor. The pixel data is arranged in the frame buffer in rows and columns that correspond to rows and columns on the display monitor. To display a graphical image on the display monitor, the pixel data is transferred from the frame buffer memory and converted to an analog signal by a digital to analog converter (DAC). In a system having multi-format pixel data, each pixel format must be converted to a standard format for the video monitor before conversion to the analog signal. The analog signal is input to the display monitor to generate the graphical display.

The size and performance of the frame buffer is dictated by a number of factors including, but not limited to, the display refresh, number of monitor pixels, monitor clock rate, data read/write frequency, and memory bandwidth. For high-resolution systems, the display refresh process consumes an appreciable portion of the total bandwidth available from the memory. During display refresh, pixel data is retrieved out of the frame buffer by the display controller pixel by pixel as the corresponding pixels on the display are refreshed. The size of the frame buffer thus directly corresponds to the number of pixels in each display frame and the number of bits in each word used to define each pixel.

Chipset integrated graphics controllers are increasingly being implemented in a uniform memory architecture (UMA) in which the frame buffer memory is part of the main system memory. In particular, in order to contain costs, the frame buffer and the system memory are incorporated into a unified or shared memory, thus allowing manufacturers of computer equipment to reduce costs by eliminating the need for a separate memory for the frame buffer. Incorporating the frame buffer and the system memory within a shared memory is furthermore desirable, as it allows unused portions of the frame buffer to be employed as a system memory when all, or even a portion, of the frame buffer is not in use. A UMA is typically implemented by providing an array of DRAM accessible by both the memory controller and the graphics controller, the associated memory space of the DRAM array being partitioned between system memory and the frame buffer.

While the implementation of the UMA provides a number of cost benefits, such memory configurations suffer from a lowered memory bandwidth, as the frame buffer memory bandwidth is typically constrained by the speed of the memory devices available. While the UMA has significant advantages regarding cost and flexibility, the additional drain on memory bandwidth caused by the constant need to maintain screen refresh may impact overall performance. As display rates and screen resolutions increase, performance is more seriously impacted. The frame buffer is simultaneously being burdened with other tasks such as cell refresh, off-screen memory accesses and writes to the on-screen memory. In some cases, the degradation of performance to the central processing unit (CPU) caused by the reduced effective memory bandwidth can be a significant problem for a conventional 1280 by 1024 pixel display operating at a refresh frequency of 85 Hz.

One potential solution to the bandwidth problem is to integrate the frame buffer, which is typically constructed from a dynamic random access memory (DRAM) device, into the graphics component. In particular, an integrated DRAM is used as the frame buffer for the display, lessening the bandwidth load on the main system memory. However, this solution is generally commercially unviable in that the cost of integrating a large capacity DRAM on a graphics controller is too high. Most graphics controllers today use external graphics memory that is 16 MB or greater in size. The large DRAM capacity is needed for the double and triple buffering of the frame buffer that software applications require, plus the additional off-screen storage of textures and so forth. Consequently, the cost of integrating 16 MB or 32 MB of DRAM on a graphics controller is too high to be a practical solution.

What is needed therefore is a system and method for integrating chipset integrated graphics controllers onto a UMA without negatively impacting performance or cost.

### BRIEF DESCRIPTION OF THE DRAWINGS

FIG. 1 is a block diagram of showing a computer system in which the scan synchronized dual frame buffer architecture can be implemented.

FIG. 2(a) is an illustration of the operation of a tile copy when a set of pixels is updated in the primary frame buffer in frame N.

FIG. 2(b) is an illustration of the operation of a tile copy when a set of pixels is updated in the primary frame buffer in frame N+1.

FIG. 3 is a flowchart of an algorithm for implementing the scan synchronized dual frame buffer architecture illustrated in FIG. 1.

### DETAILED DESCRIPTION OF THE ILLUSTRATED EMBODIMENTS

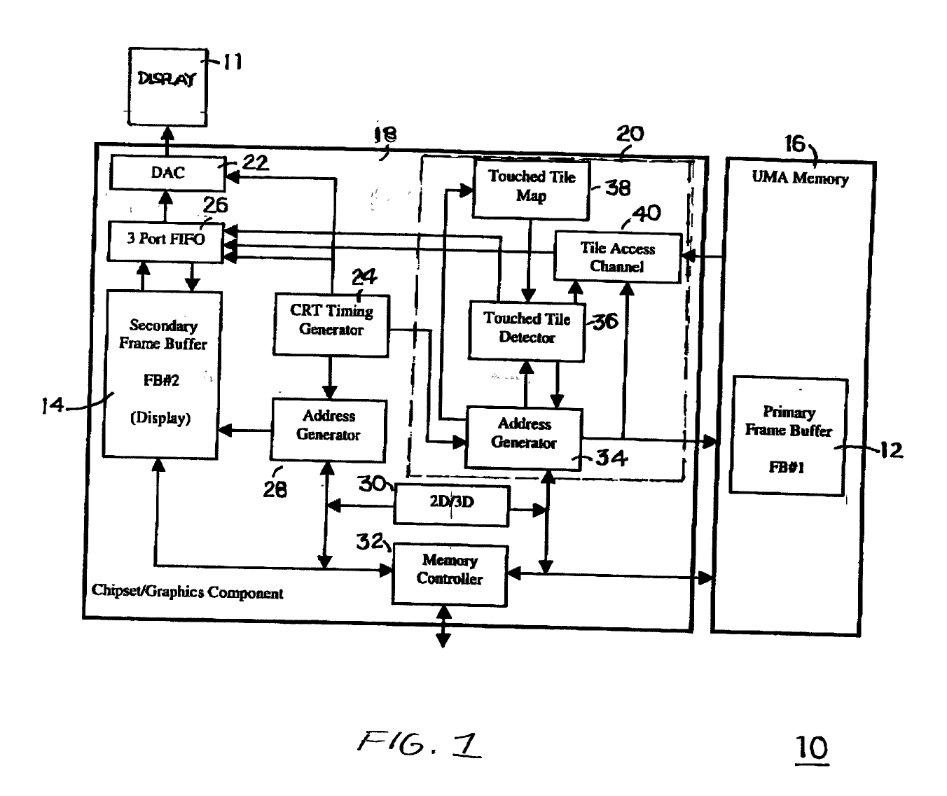

Referring to FIG. 1, the present invention provides a frame buffer architecture 10 including primary and secondary frame buffers 12 and 14, respectively, corresponding to a display 11. The primary frame buffer 12 is implemented as part of a unified memory architecture (UMA) memory 16, residing anywhere within the system memory space, and the secondary frame buffer 14 is implemented on a chipset/graphics component 18 that is in communication with the UMA memory 16. The primary frame buffer 12 maintains an image on a display 11. In operation, changing a pixel in the primary frame buffer 12 causes the corresponding pixel on the display 11 to change. In particular, the secondary frame buffer 14 maintains various functions, including display refresh, thus alleviating the bandwidth demands on the primary frame buffer 12 and the main system memory 16. One skilled in the art will recognize that the secondary frame buffer 14 could be adapted to perform other operations that require bandwidth, including but not limited to, drawing operations.

In a typical operation, not every pixel in the frame buffer is changing on every complete scan of the display 11. Consequently, most of the bandwidth for maintaining the display 11 would be handled by the secondary frame buffer 14, returning substantially all of the bandwidth back to the UMA memory 16. The extra bandwidth for the primary frame buffer 12 can be used for handling the background tasks of the operating system, local area network, three-dimensional calculations, virus scan, and so forth. Additionally, there are significant power savings gained by removing the display refresh activity from the UMA memory 16.

In operation, when a pixel is changed in the primary frame buffer 12, that pixel is copied to the secondary frame buffer 14 when the pixel is needed by the display 11. In particular, the pixel is transmitted simultaneously to the digital to analog converter (DAC) 22 and the secondary frame buffer 14, synchronized to the display refresh. This action mimics the effect the primary frame buffer 12 would have on the display 11 if the primary frame buffer 12 were the actual frame buffer maintaining the display 11.

The present invention is not dependent upon where the primary and secondary frame buffers 12 and 14, respectively, are implemented. For illustrative purposes, however, the present invention is described and illustrated with the primary frame buffer 12 implemented as part of a unified memory architecture (UMA) memory 16, residing anywhere within the system memory space, and the secondary frame buffer 14 implemented on a chipset/graphics component 18 that is in communication with the UMA memory 16.

The UMA memory 16 is typically implemented by providing an array of DRAM accessible by at least the primary frame buffer detector 20 and the memory controller 32, the associated memory space of the DRAM array being partitioned between system memory and the primary frame buffer 12. It will be appreciated that the size and location of the primary frame buffer 12 within the UMA memory 16 are definable and can be modified depending on the requirements of the computer system. The secondary frame buffer 14 can be implemented utilizing a minimal amount of memory, thus requiring less memory integration on the chipset/graphics component 18. In a typical embodiment, the width of the secondary frame buffer memory, typically a dynamic random access memory (DRAM), need only be twenty-four (24) bits since its primary function is to maintain images on the display 11. The 24 bits would be allocated to RGB, with eight (8) bits allocated for each color component.

Referring to FIG. 1, the chipset/graphics component 18 includes a primary frame buffer detector 20, DAC 22, CRT timing generator 24, FIFO 26, secondary frame buffer address generator 28, 2D/3D engine 30 and memory controller 32. The primary frame buffer detector 20 detects changes in the primary frame buffer 12 and copies those changes to the secondary frame buffer 14. The pixels fetched from the primary frame buffer 12 are eventually fed to the FIFO 26 and then passed on to the DAC 22, which converts the pixels into analog RGB signals for use by the display 11. In this manner, the pixels in the primary frame buffer 12 appear on the screen in their proper position and the displayed image is maintained.

The primary frame buffer detector 20 includes a primary frame buffer address generator 34, touched tile detector 36, touched tile map 38 and tile access channel 40. The CRT timing generator 24 is coupled to the DAC 22, primary frame buffer address generator 34 and secondary frame buffer address generator 28. In operation, the CRT timing generator 24 creates the synchronization timing for the display 11 as well as the X and Y position indicators on the CRT beam position. The X and Y position indicators are fed from the CRT timing generator 24 to the primary frame buffer address generator 34 in order to convert the X and Y positions into addresses used to fetch pixels from the primary frame buffer 12.

A pixel may be updated in the primary frame buffer 12 via the memory controller 32 or the 2D/3D engine 30 or some manner well known in the art. The memory controller 32 is coupled to the UMA memory 16 by a bus, which includes control and address lines, which are coupled to the control, address and data lines of the UMA memory. The memory controller 32 accesses the primary frame buffer 12 within the UMA memory 16 for the purposes of storing and retrieving graphics data therein for ultimate display on a the display device 11 which is coupled to the chipset/graphics component 18. The memory controller 32 receives graphics, data and commands via a peripheral bus. Such graphics, data and commands originate from a processor or a number of other devices or components connected to the peripheral bus, in a manner well known in the art.

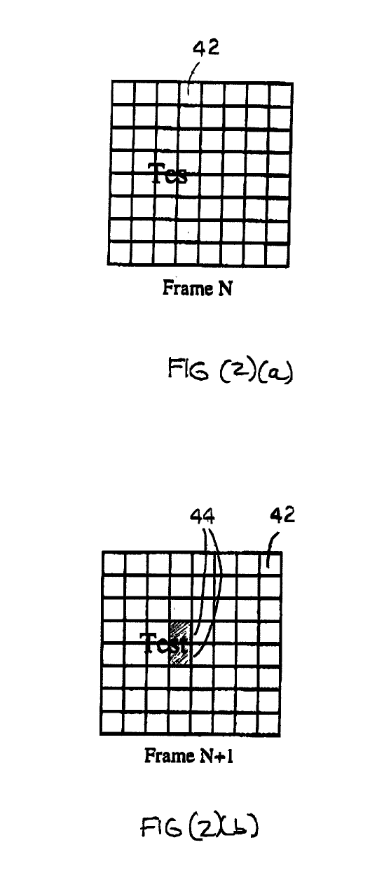

Referring to FIGS. 1 and 2(a)-(b), the primary frame buffer 12 is divided into smaller regions called tiles 42. Tiles 42 are areas of the screen that represent blocks of pixels. The tiles are generally rectangular shaped areas although one skilled in the art will recognize that they may be of any geometric shape. The present invention is not dependent on the size of the tiles 42, which can be any size, including a single pixel. Generally, smaller tiles 42 require a larger touched tile map 38 while larger tiles 42 require a smaller touched tile map 38.

When a pixel is updated (e.g. such as by a user inputting a letter from a keyboard), the memory controller 32 and/or 2D/3D engine 30 notifies the primary frame buffer detector 20 and primary frame buffer address generator 34. The primary frame buffer address generator 34 determines the updated pixel's address and notifies the touched tile detector 36. The touched tile detector 36 decodes the pixel's address and updates the touched tile map 38. Any pixel that is updated (i.e. touched) in the primary frame buffer 12 causes all the pixels in its tile 42 to be tagged for copying to the secondary frame buffer 14 at the next pass of the CRT beam.

As the display 11 is being refreshed, the CRT timing generator 24 provides the X and Y position information to the primary frame buffer address generator 34, which is in communication with the touched tile map 38. This information is used to fetch the proper location in the touched tile map 38 to pass on to the touched tile detector 36. If the display 11 is about to cover an area of a tile 42 that has been updated (i.e. touched), the touched tile detector 36 will signal the tile access channel 40, secondary frame buffer address generator 28 and FIFO 26 to pass the data from the primary frame buffer 12 to the DAC 22 and the secondary frame buffer 14.

Referring to FIGS. 2(a) and (b), the operation of the present invention is illustrated with a set of pixels that are updated in the primary frame buffer 12. In particular, the user is attempting to input the letters for the word “Test”. Referring to FIG. 2(a), in “Frame N”, the letters “Tes” have been sitting in both the primary and secondary frame buffers 12 and 14 for many milliseconds because of previous copy operations. Frame N no longer has any “touched” tiles 42 from the primary frame buffer 12 since the image has been stable for many milliseconds.

Referring to FIG. 2(b), in “Frame N+1”, sometime after the CRT beam has passed the letters “Tes” in “Frame N”, the final “t” is drawn in the primary frame buffer 12. The shaded tiles 44 are the tiles associated with the letter “t” that will be fetched from the primary frame buffer 12 for display and simultaneously copied to the secondary frame buffer 14. This action tags the shaded tiles 44 as touched. When Frame N+1 is displayed on the monitor, the shaded areas 44 will come from the primary frame buffer 12 and will be simultaneously written into the secondary frame buffer 14. The memory holding the primary frame buffer 12 will suffer a small impact on its available bandwidth as the information is fetched. After the copy operation is completed, the display 11 reverts back to fetching pixels only from the secondary frame buffer 14 and the touched tiles 44 are reset to the untouched tile state (i.e., tile 42).

Referring to FIG. 2(b), there are many pixels copied in this frame that were not parts of the “t”. For example, the pixels associated with the letter “s” are copied since they are associated with the same touched tile 44. This is the tile size tradeoff discussed above. In particular, smaller sized tiles 42 require a larger sized touched tile map 38 while larger sized tiles 42 require a smaller sized touched tile map 38. A smaller tile size would generally be more efficient at copying just the pixels that needed to be copied. For example, a tile size of 32 pixels by 16 lines is generally a good compromise between touched tile map size and copying efficiency.

The bandwidth of the secondary frame buffer 14 during the copy operation of the shaded areas is used to write the information into the secondary frame buffer 14. The secondary frame buffer memory goes through the same access patterns, but instead performs write operations instead of read operations.

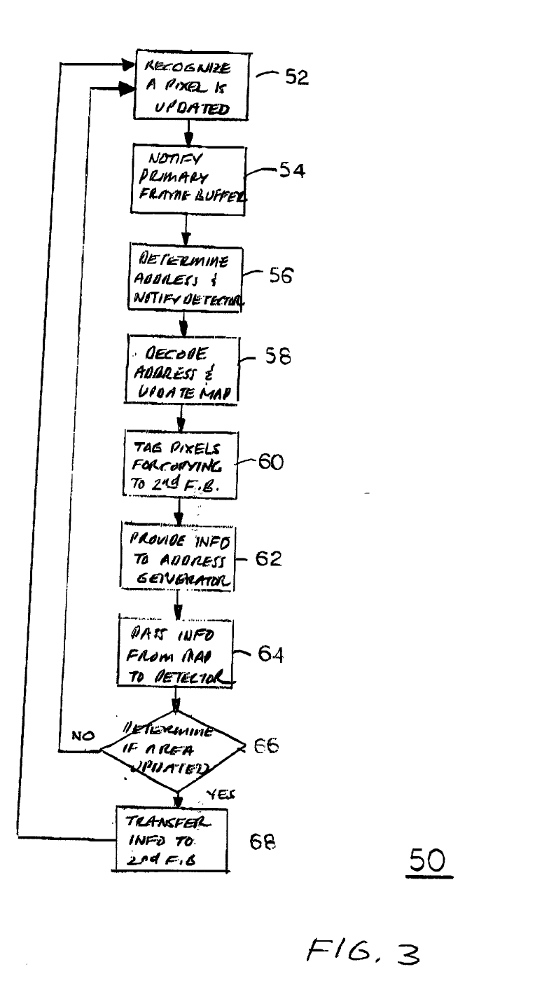

Referring to FIG. 3, a flowchart 50 of an algorithm for implementing the scan synchronized dual frame buffer architecture is illustrated. The memory controller 32 and/or 2D/3D engine 30 recognizes when a pixel is updated in accordance with conventional techniques (step 52). One skilled in the art will recognize that a pixel can be updated through many different ways and the present invention is not reliant on any particular method. For example, a user can update a pixel by writing over existing letters (i.e. modifying existing pixels), inputting an additional letter (i.e. adding pixels) and so forth. When a pixel is updated (e.g. such as by a user inputting a letter from a keyboard), the memory controller 32 and/or 2D/3D engine 30 notifies the primary frame buffer detector 20 and primary frame buffer address generator 34 (step 54). The primary frame buffer address generator 34 determines the updated pixel's address and notifies the touched tile detector 36 (step 56). The touched tile detector 36 decodes the pixel's address and updates the touched tile map 38 (step 58). Any pixel that is updated (i.e. touched) in the primary frame buffer 12 causes all the pixels in its tile 42 to be tagged for copying to the secondary frame buffer 14 at the next pass of the CRT beam (step 60). As the display 11 is being refreshed, the CRT timing generator 24 provides the X and Y position information to the primary frame buffer address generator 34, which is in communication with the touched tile map 38 (step 62). This information is used to fetch the proper location in the touched tile map 38 to pass on to the touched tile detector 36 (step 64). If the display 11 is about to cover an area of a tile 42 that has been updated (i.e. touched) (step 66), the touched tile detector 36 will signal the tile access channel 40, secondary frame buffer address generator 28 and FIFO 26 to pass the data from the primary frame buffer 12 to the DAC 22 and the secondary frame buffer 14 (step 68). If the display 11 is not about to cover any updated pixel information, no action is taken.

In accordance with another embodiment of the invention, the enabling of touched tile hits are held off until all of the operations on the primary frame buffer 12 are completed. This would eliminate any drawing time artifacts from showing on the screen by emulating double buffering. The enabling of touched tile hits could also be timed to the vertical refresh period of the display 11. All of the tiles 42 could also appear as touched with a single command, forcing a complete update of the screen and secondary frame buffer 14.

Furthermore, the FIFO 26 could also be expanded to increase the capabilities of the present invention, including but not limited to, functions such as blending, scaling, color space conversion and so forth. The FIFO 26 could also be made to work in tandem with the primary frame buffer 12 if bandwidth was not a concern. This would allow the secondary frame buffer 14 to be the video overlay surface or another graphics surface that could be mixed with the output from the primary frame buffer 12.

Having now described the invention in accordance with the requirements of the patent statutes, those skilled in the art will understand how to make changes and modifications to the present invention to meet their specific requirements or conditions. Such changes and modifications may be made without departing from the scope and spirit of the invention as set forth in the following claims.

What is claimed is:

1. A dual frame buffer system, comprising:
a first frame buffer;
a second frame buffer; and
a controller for copying data from the first frame buffer to the second frame buffer when data is changed in the first frame buffer and data is needed for refreshing the display monitor.

2. The dual frame buffer system claimed in claim 1, wherein the controller further comprises copying the data simultaneously from the first frame buffer to the second frame buffer.

3. The dual frame buffer system claimed in claim 1, further comprising:
a first address generator corresponding to the first frame buffer;
a second address generator corresponding to the second frame buffer; and
a timing generator for coordinating the timing between the first and second address generators for refreshing the display monitor.

4. The dual frame buffer system claimed in claim 3, further comprising:
a detector for detecting when an update is made to the data in the first frame buffer; and
a decoder for decoding the location of the updated data, wherein the controller transmits the updated data from the first frame buffer to the second frame buffer when the display is refreshed.

5. The dual frame buffer system claimed in claim 4, wherein the first frame buffer comprises a plurality of regions.

6. The dual frame buffer claimed in claim 5, wherein the controller transmits those regions corresponding to the updated data from the first frame buffer to the second frame buffer when the display is refreshed.

7. The dual frame buffer claimed in claim 1, wherein the first frame buffer is part of a unified memory architecture.

8. The dual frame buffer claimed in claim 7, wherein the second frame buffer stores data used to refresh the display monitor.

9. A unified memory architecture system comprising:
a unified memory including a main memory and a primary frame buffer memory;
a secondary frame buffer memory; and
a controller for copying pixel data from the primary frame buffer memory to the secondary frame buffer memory when pixel data is changed in the primary frame buffer memory and needed for refreshing the display monitor.

10. The system claimed in claim 9, wherein the controller further comprises transmitting the pixel data simultaneously from primary frame buffer memory to the secondary frame buffer memory.

11. The system claimed in claim 10, further comprising:
a primary address generator corresponding to the primary frame buffer memory;
a secondary address generator corresponding to the secondary frame buffer memory; and
a timing generator for coordinating the timing between the primary and secondary address generators for refreshing the display monitor.

12. The system claimed in claim 11, further comprising:
a detector for detecting when an update is made to the pixel data in the primary frame buffer memory; and
a decoder for decoding the location of the updated pixel data, wherein the controller transmits the updated pixel data from the primary frame buffer memory to the secondary frame buffer memory when the display is refreshed.

13. The system claimed in claim 12, wherein the primary frame buffer memory is partitioned into a plurality of regions.

14. The system claimed in claim 13, wherein the controller transmits those regions containing the updated pixel data from the primary frame buffer memory to the secondary frame buffer memory when the display is refreshed.

15. A method of refreshing a display, comprising:
identifying data which is changed in a first frame buffer memory;
providing the data to a display controller; and
copying data from a first frame buffer memory to a second frame buffer memory when data is changed in the first frame buffer memory and needed for refreshing the display.

16. The method claimed in claim 15, further comprising:
transmitting the pixel data simultaneously from the first frame buffer memory to the second frame buffer memory.

17. The method claimed in claim 15, further comprising:
detecting when an update is made to the pixel data in the first frame buffer memory; and
decoding the location of the updated pixel data; and
transmitting the updated pixel data from the first frame buffer memory to the second frame buffer memory when the display is refreshed.

18. The method claimed in claim 15, further comprising:
partitioning the first frame buffer memory into a plurality of regions.

19. The method claimed in claim 19, further comprising:
transmitting those regions containing the updated pixel data from the first frame buffer memory to the second frame buffer memory when the display is refreshed.

20. The method claimed in claim 15, wherein the first frame buffer memory is part of a uniform memory architecture memory.

21. A computer product for refreshing a display, comprising:
first computer readable program code embodied in a computer usable medium to cause a computer to identify data which is changed in a first frame buffer memory;
second computer readable program code embodied in a computer usable medium to cause a computer to provide the data to a display controller; and
third computer readable program code embodied in a computer usable medium to cause a computer to copy data from a first frame buffer memory to a second frame buffer memory when data is changed in the first frame buffer memory and needed for refreshing the display.

22. The computer product claimed in claim 21, further comprising:
third computer readable program code embodied in a computer usable medium to cause a computer to transmit the pixel data simultaneously from the first frame buffer memory to the second frame buffer memory.

23. The computer product claimed in claim 21, further comprising:
third computer readable program code embodied in a computer usable medium to cause a computer to detect when an update is made to the pixel data in the first frame buffer memory; and
fourth computer readable program code embodied in a computer usable medium to cause a computer to decode the location of the updated pixel data; and
fifth computer readable program code embodied in a computer usable medium to cause a computer to transmit the updated pixel data from the first frame buffer memory to the second frame buffer memory when the display is refreshed.

24. The computer product claimed in claim 21, further comprising:
third computer readable program code embodied in a computer usable medium to cause a computer to partition the first frame buffer memory into a plurality of regions.

25. The computer product claimed in claim 21, further comprising:
third computer readable program code embodied in a computer usable medium to cause a computer to transmit those regions containing the updated pixel data from the first frame buffer memory to the second frame buffer memory when the display is refreshed.
